(19) United States
(12) Patent Application Publication
(10) Pub. No.: US 2009/0245797 A1
(43) Pub. Date: Oct. 1, 2009

(54) COMMUNICATION SYSTEM AND APPARATUS

(75) Inventors: Osamu TSURUMI, Kawasaki (JP); Hiroyuki Kaneko, Kawasaki (JP); Shotaro Ide, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/367,625

(22) Filed: Feb. 9, 2009

(30) Foreign Application Priority Data
Mar. 28, 2008 (JP) 2008-087008

(51) Int. Cl. H04J 14/02

(52) U.S. Cl. 398/79

(57) ABSTRACT

A communication system includes a first communication apparatus included in an initial station, the first communication apparatus transmitting a signal to the intermediate station on a later stage, the first communication apparatus receiving a signal sent from the terminal station and passed through the intermediate station, a second communication apparatus included in the intermediate station, the second communication apparatus receiving a signal from a preceding station and transmitting the signal to a later station, the second communication apparatus passing a signal from the later station to the preceding station, and a third communication apparatus included in the terminal station, the third communication apparatus receiving a signal from the intermediate station on a preceding stage, the third communication apparatus transmitting a signal being passed through the intermediate station and being received at the initial station.

### CROSS-REFERENCE TO RELATED APPLICATIONS

This application is based upon and claims the benefit of priority of the prior Japanese Patent Application No. 2008-087008, filed on Mar. 28, 2008, the entire contents of which are incorporated herein by reference.

### FIELD

An embodiment discussed herein relates to a communication system and a communication apparatus.

### BACKGROUND

In an optical network of a communication carrier, a wavelength division multiplexing (WDM) apparatus is configured to multiplex (e.g., time division multiplex) a plurality of client signals (e.g., of gigabit Ethernet (trademark), fast Ethernet, STM-0/OC-1, STM-1/OC-3, STM-4/OC-12, STM-16/OC-48) into a signal of one wavelength so as to transmit the multiplexed (e.g., time division multiplexed) signal.

A WDM system is an effective way to avoid channels of low speed client signals occupying limited wavelengths of the network. This system is employed by each of apparatus vendors in spite of differences in multiplexing methods. A WDM apparatus has a multiplexer unit for each of the wavelengths so as to add or drop the multiplexed client signal at any nodes, e.g., as disclosed in Japanese Laid-open Patent Publication No. 10-041889.

In a ring type communication system, each of communication apparatuses may transmit an optical signal including a plurality of client signals multiplexed with each other in both rightward line and leftward line so as to be ready for a UPSR (unidirectional path switched ring) system. Either one of the optical signals sent from both lines is selected and received on a receiving line.

### SUMMARY

According to an aspect of an embodiment, a communication system having an initial station, an intermediate station and a terminal station linearly connected to one another, the stations being configured to drop or send a received signal, the stations being configured to add another signal to the sent signal, the communication system includes a first communication apparatus included in an initial station, the first communication apparatus transmitting a signal to the intermediate station on a later stage, the first communication apparatus receiving a signal sent from the terminal station and passed through the intermediate station, a second communication apparatus included in the intermediate station, the second communication apparatus receiving a signal from a preceding station and transmitting the signal to a later station, the second communication apparatus passing a signal from the later station to the preceding station, and a third communication apparatus included in the terminal station, the third communication apparatus receiving a signal from the intermediate station on a preceding stage, the third communication apparatus transmitting a signal being passed through the intermediate station and being received at the initial station.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a communication system according to an embodiment;

FIG. 2 is a block diagram showing a modification of a through path shown in FIG. 1;

FIG. 3 is a sequence diagram showing an example of a setting procedure of a SUB ch;

FIG. 4 is a diagram showing a table made at a step S303 shown in FIG. 3;

FIG. 5 is a diagram showing a table made at a step S306 shown in FIG. 3;

FIG. 6 is a diagram showing a table made at a step S309 shown in FIG. 3;

FIG. 7 is a diagram showing a table made at a step S312 shown in FIG. 3;

FIG. 8 is a diagram showing a table shared by each of communication apparatuses;

FIG. 9 is a sequence diagram showing an example of a setting procedure of a path;

FIG. 10 is a block diagram showing a specific example of forming the communication apparatus; and

FIG. 11 is a block diagram showing a modification of the communication system shown in FIG. 1.

### DESCRIPTION OF EMBODIMENTS

A preferred embodiment of a communication system and a communication apparatus discussed herein will be described in detail with reference to the drawings.

### First Embodiment

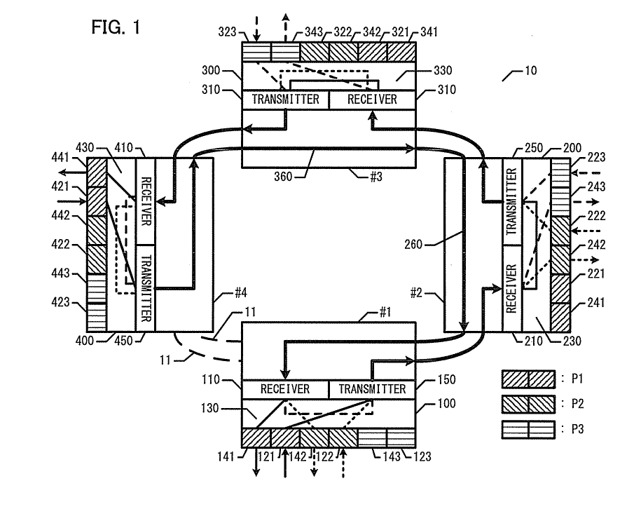

FIG. 1 is a block diagram showing functional blocks of a communication system of the embodiment. As shown in FIG. 1, a communication system 10 of the embodiment has communication apparatuses #1-#4. The communication apparatus #1 is included in an initial station, the communication apparatuses #2-#3 are included in intermediate station and the communication apparatus #4 is included in a terminal station, and the communication apparatuses #1-#4 are logically linearly connected.

“Logically linearly connected” means that a linear transmission path is formed between the communication apparatuses #1-#4, regardless of how the communication apparatuses #1-#4 are physically connected to one another. In this case, the communication apparatuses #1-#4 are connected to form a ring by using optical fibers. The communication apparatuses #1-#4 are logically linearly connected without using a path 11 between the communication apparatuses #1 and #4.

Each of the communication apparatuses #1-#4 is a WDM apparatus configured to multiplex optical signals of different wavelengths and to transmit and receive the optical signals to and from one another. Each of the communication apparatuses #1-#4 has a plurality of multiplexer units related to a plurality of wavelengths. Only one of the plural multiplexer units of each of the communication apparatuses #1-#4 is shown in FIG. 1.

More specifically, as shown in FIG. 1, the communication apparatuses #1-#4 have multiplexer units 100, 200, 300 and 400, respectively. The multiplexer units 100, 200, 300 and 400 transmit and receive signals to and from one another by using a same wavelength 1.

Each of the multiplexer units 100, 200, 300 and 400 is configured to time division multiplex the signals, and any one of the above multiplexer units is configured to add and drop the signals, so that a path may be established between any two of the multiplexer units. A plurality of paths may be established between any two of the multiplexer units so that a plurality of channels may be implemented for the same wavelength.

It is assumed here that up to four channels may be established among the multiplexer units 100, 200, 300 and 400. Each of the multiplexer units has input ports given the port numbers P1-P4, and output ports given the port numbers P1-P4. The port numbers P1-P4 correspond to the four channels, respectively. Each of the input ports and each of the output ports are connected to an external device (on a client side) of the communication system 10.

A configuration of the multiplexer unit 100 of the communication apparatus #1, which is included in the initial station, will be described below. The multiplexer unit 100 has a receiver 110, input ports 121-123, a signal processor 130, output ports 141-143 and a transmitter 150. The input ports 121-123 correspond to the port numbers P1-P3, respectively. The output ports 141-143 correspond to the port numbers P1-P3, respectively.

The receiver 110 is configured to receive an optical signal that is transmitted from the communication apparatus #4, which is included in the terminal station, and passes the communication apparatuses #3 and #2, which are included in the intermediate station(s). The communication apparatuses #2 and #3 may be included in one intermediate station or in a different intermediate station. The receiver 110 is configured to transform the received optical signal into an electrical signal and to provide the signal processor 130 with the electrical signal. Each of the input ports 121-123 is configured to be provided with an input signal addressed to one of the communication apparatuses #2-#4 (addressed to the remaining stations). The input ports 121-123 are configured to provide the signal processor 130 with the input signals.

The signal processor 130 is configured to provide one of the output ports 141-143 with the signal provided by the receiver 110 and addressed to one of the output ports 141-143 (addressed to the communication apparatus #1) in accordance with the address of the signal (i.e., to drop the signal). The signal processor 130 is configured to provide the transmitter 150 with the signal provided by the receiver 110 and addressed to one of the remaining stations (i.e., to loop back the signal).

The signal processor 130 is configured to time division multiplex the signals provided by the input ports 121-123, and to provide the transmitter 150 with the multiplexed signal(i.e., to add the signal). The output ports 141-143 are configured to output the signal provided by the signal processor 130 to the external device of the communication system 10. The transmitter 150 is configured to transform the signal provided by the signal processor 130 into an optical signal so as to transmit the optical signal to the communication apparatus #2.

A configuration of the multiplexer unit 200 of the communication apparatus #2 that is included in one of the intermediate stations will be described below. The multiplexer unit 200 has a receiver 210, input ports 221-223, a signal processor 230, output ports 241-243, a transmitter 250, and a through path 260. The input ports 221-223 correspond to the port numbers P1-P3, respectively. The output ports 241-243 correspond to the port numbers P1-P3, respectively.

The receiver 210 is configured to receive an optical signal transmitted from the communication apparatus #1 that is included in a preceding station of the communication apparatus #2. The receiver 210 is configured to transform the received optical signal into an electrical signal and to provide the signal processor 230 with the electrical signal. Each of the input ports 221-223 may be provided with an input signal addressed to one of the output ports of the communication apparatuses #1, #3 and #4. The input ports 221-223 are configured to provide the signal processor 230 with the input signals.

The signal processor 230 is configured to provide one of the output ports 241-243 with the signal provided by the receiver 210 and addressed to one of the output ports 241-243 (addressed to the communication apparatus #2) in accordance with the address of the signal (i.e., to drop the signal). The signal processor 230 is configured to time division multiplex the signals addressed to one of the output ports of the communication apparatuses #1, #3 and #4 and to provide the transmitter 250 with the multiplexed signal (i.e., to loop back the signal).

The signal processor 230 is configured to time division multiplex the signals provided by the input ports 221-223, and to provide the transmitter 250 with the multiplexed signal(i.e., to add the signal). The output ports 241-243 are configured to output the signal provided by the signal processor 230 to the external device of the communication system 10. The transmitter 250 is configured to transform the signal provided by the signal processor 230 into an optical signal and transmits the optical signal to the communication apparatus #3 that is included in a later station of the communication apparatus #2.

The through path 260 is configured to pass signals from the communication apparatus #3, which is included in the later station, to the communication apparatus #1, which is included in the preceding station. The signals passed by the through path 260 include a signal addressed to the communication apparatus #2 and a signal addressed to one of the remaining stations. In this way, the communication apparatus #2 may drop or loop back the signal transmitted from the communication apparatus #1 in accordance with the address of the signal. The communication apparatus #2 is configured to pass a signal transmitted from the communication apparatus #3 to the communication apparatus #1 regardless of the address of the signal.

A configuration of the multiplexer unit 300 of the communication apparatus #3 that is included in one of the intermediate stations will be described below. The multiplexer unit 300 has a receiver 310, input ports 321-323, a signal processor 330, output ports 341-343, a transmitter 350, and a through path 360. The input ports 321-323 correspond to the port numbers P1-P3, respectively. The output ports 341-343 correspond to the port numbers P1-P3, respectively.

The receiver 310 is configured to receive an optical signal transmitted from the communication apparatus #2, which is included in a preceding station of the communication apparatus #3. The receiver 310 is configured to transform the received optical signal into an electrical signal and to provide the signal processor 330 with the electrical signal. Each of the input ports 321-323 may be provided with an input signal addressed to one of the output ports of the communication apparatuses #1, #2 and #4. The input ports 321-323 are configured to provide the signal processor 330 with the input signals.

The signal processor 330 is configured to provide one of the output ports 341-343 with the signal provided by the receiver 310 and addressed to one of the output ports 341-343 (addressed to the communication apparatus #3) in accordance with the address of the signal (i.e., to drop the signal). The signal processor 330 is configured to time division multiplex the signals addressed to one of the output ports of the communication apparatuses #1, #2 and #4 and to provide the transmitter 350 with the multiplexed signal (i.e., to loop back the signal).

The signal processor 330 is configured to time division multiplex the signals provided by the input ports 321-323, and to provide the transmitter 350 with the multiplexed signal(i.e., to add the signal). The output ports 341-343 are configured to output the signal provided by the signal processor 330 to the external device of the communication system 10. The transmitter 350 is configured to transform the signal provided by the signal processor 330 into an optical signal and transmits the optical signal to the communication apparatus #4, which is included in a later station of the communication apparatus #3.

The through path 360 is configured to pass signals from the communication apparatus #4, which is included in the later station, to the communication apparatus #2, which is included in the preceding station. The signals passed by the through path 360 include a signal addressed to the communication apparatus #3 and a signal addressed to one of the remaining stations. In this way, the communication apparatus #3 may drop or loop back the signal transmitted from the communication apparatus #2 in accordance with the address of the signal. The communication apparatus #3 is configured to pass a signal transmitted from the communication apparatus #4 to the communication apparatus #2 regardless of the address of the signal.

A configuration of the multiplexer unit 400 of the communication apparatus #4, which is included in the terminal station, will be described below. The multiplexer unit 400 has a receiver 410, input ports 421-423, a signal processor 430, output ports 441-443 and a transmitter 450. The input ports 421-423 correspond to the port numbers P1-P3, respectively. The output ports 441-443 correspond to the port numbers P1-P3, respectively.

The receiver 410 is configured to receive an optical signal transmitted from the communication apparatus #3, which is included in a preceding one of the intermediate stations. The receiver 410 is configured to transform the received optical signal into an electrical signal and to provide the signal processor 430 with the electrical signal. Each of the input ports 421-423 is configured to be provided with an input signal addressed to one of the communication apparatuses #1-#3 (addressed to the remaining stations). The input ports 421-423 are configured to provide the signal processor 430 with the input signals.

The signal processor 430 is configured to provide one of the output ports 441-443 with the signal provided by the receiver 410 and addressed to one of the output ports 441-443 (addressed to the communication apparatus #4) in accordance with the address of the signal (i.e., to drop the signal). The signal processor 430 is configured to provide the transmitter 450 with the signal provided by the receiver 410 and addressed to one of the remaining stations (i.e., to loop back the signal).

The signal processor 430 is configured to time division multiplex the signals provided by the input ports 421-423, and to provide the transmitter 450 with the multiplexed signal(i.e., to add the signal). The output ports 441-443 are configured to output the signal provided by the signal processor 430 to the external device of the communication system 10. The transmitter 450 is configured to transform the signal provided by the signal processor 430 into an optical signal. The transmitter 450 is configured to transmit the optical signal to the communication apparatus #1, the optical signal being passed through the communication apparatuses #3 and #2, which are included in the intermediate stations.

Each of the receivers 110, 210, 310 and 410 is formed by including, e.g., a photo diode (PD). Each of the signal processors 130, 230, 330 and 430 is formed by including, e.g., a central processing unit (CPU). Each of the transmitters 150, 250, 350 and 450 is formed by including, e.g., a laser diode (LD). Each of the through paths 260 and 360 is formed by including, e.g., an optical fiber.

As shown by a solid line in FIG. 1, a path of the port number 1 (P1) is established between the communication apparatuses #1 and #4. As shown by a small dotted line, a path of the port number 2 (P2) is established between the communication apparatuses #1 and #2. As shown by a rough dotted line, a path of the port number 3 (P3) is established between the communication apparatuses #2 and #3. Each of bold lines with arrows represents a path on which the solid, small dotted and rough dotted paths are time division multiplexed.

The path between the communication apparatuses #1 and #4 (the solid path of P1) will be explained below. A signal addressed to the output port 441 of the communication apparatus #4 is input to the input port 121 of the communication apparatus #1 so as to be added. The added signal input to the input port 121 is transmitted to the communication apparatus #2. As the signal transmitted from the communication apparatus #1 is addressed to one of the remaining stations, the communication apparatus #2 loops back and transmits the signal to the communication apparatus #3.

As the signal transmitted from the communication apparatus #2 is addressed to one of the remaining stations, the communication apparatus #3 loops back and transmits the signal to the communication apparatus #4. As the signal transmitted from the communication apparatus #3 is addressed to its own output port 441, the communication apparatus #4 outputs the signal from the output port 441 so as drop the signal.

Meanwhile, a signal addressed to the output port 141 of the communication apparatus #1 is input to the input port 421 of the communication apparatus #4 so as to be added. The added signal input to the input port 421 passes the communication apparatuses #3 and #2 and is transmitted to the communication apparatus #1. The communication apparatus #3 passes the signal from the communication apparatus #4 to the communication apparatus #2. The communication apparatus #2 passes the signal from the communication apparatus #3 to the communication apparatus #1. As the signal transmitted from the communication apparatus #2 is addressed to its own output port 141, the communication apparatus #1 outputs the signal from the output port 141 so as to drop the signal.

The path between the communication apparatuses #1 and #2 (the small dotted path of P2) will be explained below. A signal addressed to the output port 242 of the communication apparatus #2 is input to the input port 122 of the communication apparatus #1 so as to be added. The added signal input to the input port 122 is transmitted to the communication apparatus #2. As the signal transmitted from the communication apparatus #1 is addressed to its own output port 242, the communication apparatus #2 outputs the signal from the output port 242 so as to drop the signal.

Meanwhile, a signal addressed to the output port 142 of the communication apparatus #1 is input to the input port 222 of the communication apparatus #2 so as to be added. The added signal input to the input port 222 is transmitted to the communication apparatus #3. As the signal transmitted from the communication apparatus #2 is addressed to one of the remaining stations, the communication apparatus #3 loops back and transmits the signal to the communication apparatus #4.

As the signal transmitted from the communication apparatus #3 is addressed to one of the remaining stations, the communication apparatus #4 loops back and transmits the signal to the communication apparatus #1. The signal transmitted from the communication apparatus #4 to the communication apparatus #1 is passed the communication apparatuses #3 and #2. The communication apparatus #3 passes the signal from the communication apparatus #4 to the communication apparatus #2. The communication apparatus #2 passes the signal from the communication apparatus #3 to the communication apparatus #1.

As the signal transmitted from the communication apparatus #2 is addressed to its own output port 142, the communication apparatus #1 outputs the signal from the output port 142 so as to drop the signal.

The path between the communication apparatuses #2 and #3 (the rough dotted path of P3) will be explained below. A signal addressed to the output port 343 of the communication apparatus #3 is input to the input port 223 of the communication apparatus #2 so as to be added. The added signal input to the input port 223 is transmitted to the communication apparatus #3. As the signal transmitted from the communication apparatus #2 is addressed to its own output port 343, the communication apparatus #3 outputs the signal from the output port 343 so as to drop the signal.

Meanwhile, a signal addressed to the output port 243 of the communication apparatus #2 is input (added) to the input port 323 of the communication apparatus #3 so as to be added. The added signal input to the input port 323 is transmitted to the communication apparatus #4. As the signal transmitted from the communication apparatus #3 is addressed to one of the remaining stations, the communication apparatus #4 loops back and transmits the signal to the communication apparatus #1. The signal transmitted from the communication apparatus #3 to the communication apparatus #1 is passed the communication apparatuses #3 and #2.

The communication apparatus #3 passes the signal from the communication apparatus #4 to the communication apparatus #2. The communication apparatus #2 passes the signal from the communication apparatus #3 to the communication apparatus #1. As the signal transmitted from the communication apparatus #2 is addressed to one of the remaining stations, the communication apparatus #1 loops back and transmits the signal to the communication apparatus #2. As the signal transmitted from the communication apparatus #1 is addressed to its own output port 243, the communication apparatus #2 outputs the signal from the output port 243 so as to drop the signal.

As described above, receiving a signal only from the communication apparatus #4, which is included in the terminal station, the communication apparatus #1 adds, drops or loops back the signal. Receiving a signal only from the preceding station, each of the communication apparatuses #2-#4 adds, drops or loops back the signal. Thus, in order to establish a plurality of paths that use the wavelength λ1, it is enough that each of the communication apparatuses #1-#4 has one multiplexer unit.

Between any adjacent two of the communication apparatuses #1-#4, one optical fiber is provided in a counterclockwise direction going from the communication apparatus #1 to the communication apparatus #4, and another one optical fiber is provided in a clockwise direction going from the communication apparatus #4 to the communication apparatus #1. Although using only the wavelength λ1 as described above, the communication system 10 may provide one optical fiber between any adjacent two of the communication apparatuses #1-#4 and use different wavelengths in the clockwise and counterclockwise directions.

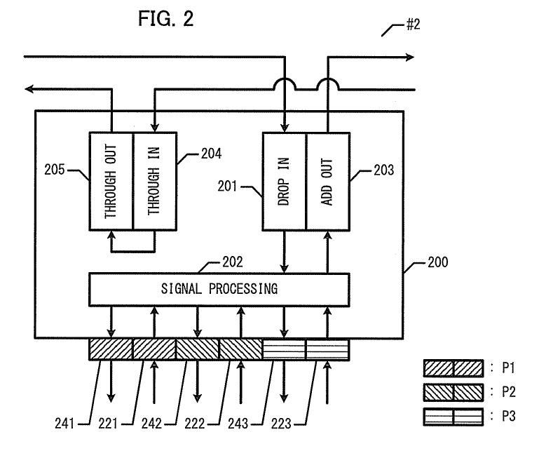

FIG. 2 is a block diagram showing a modification of the through path shown in FIG. 1. In FIG. 2, each of portions which is a same as the corresponding one shown in FIG. 1 is given a same reference numeral, and its explanation is omitted. As shown in FIG. 2, the multiplexer unit 200 has a drop in portion 201, a signal processing portion 202, an add out portion 203, a through in portion 204, a through out portion 205, the input ports 221-223 and the output ports 241-243.

The drop in portion 201 (Drop IN) corresponds to the receiver 210 shown in FIG. 1. Receiving an optical signal transmitted from the communication apparatus #1, the drop in portion 201 transforms the received optical signal into an electrical signal and provides the signal processing portion 202 with the electrical signal. The signal processing portion 202 corresponds to the signal processor 230 shown in FIG. 1.

The signal processing portion 202 determines an address of the signal provided by the drop in portion 201. If the determined address is one of ports 241-243, the signal processing portion 202 de-multiplexes a frame of the signal and provides the output port indicated by the address with the de-multiplexed signal corresponding to the address. If the determined address is one of the remaining stations, the signal processing portion 202 provides the add out portion 203 with the signal so as to relay the signal.

The signal processing portion 202 inserts the signals provided by the input ports 221-223 in a frame. The signal processing portion 202 time division multiplexes each of the de-multiplexed signals and provides the add out portion 203 with the multiplexed signal. The add out portion 203 (Add OUT) corresponds to the transmitter 250 shown in FIG. 1. The add out portion 203 transforms the signal provided by the signal processing portion 202 into an optical signal and transmit the optical signal to the communication apparatus #3.

The through in portion 204 (Through IN) and the through out portion 205 (Through OUT) correspond to the through path 260 shown in FIG. 1. The through in portion 204 is provided with an input optical signal from the communication apparatus #3. The through in portion 204 provides the through out portion 205 with the input optical signal as it is. The through out portion 205 passes the optical signal from the through in portion 204 to the communication apparatus #1.

As described above, the through path 260 may be formed by a path along which the through in portion 204 takes an optical signal into the multiplexer unit 200 and the add out portion 203 outputs the optical signal without optical/electrical conversion or signal processing. The multiplexer unit 300 has a same configuration as the multiplexer unit 200 as explained above.

The communication system 10 is a WDM communication system that may use a plurality of multiplexer units configured to use different wavelengths at the same time in addition to the multiplexer units shown in FIG. 1. The communication system 10 is configured to manage each of the multiplexer units configured to use a same wavelength as one sub-channel (SUB ch). As using the same wavelength λ1, the multiplexer units 100, 200, 300 and 400 belong to a same SUB ch. A setting procedure of a SUB ch will be explained below.

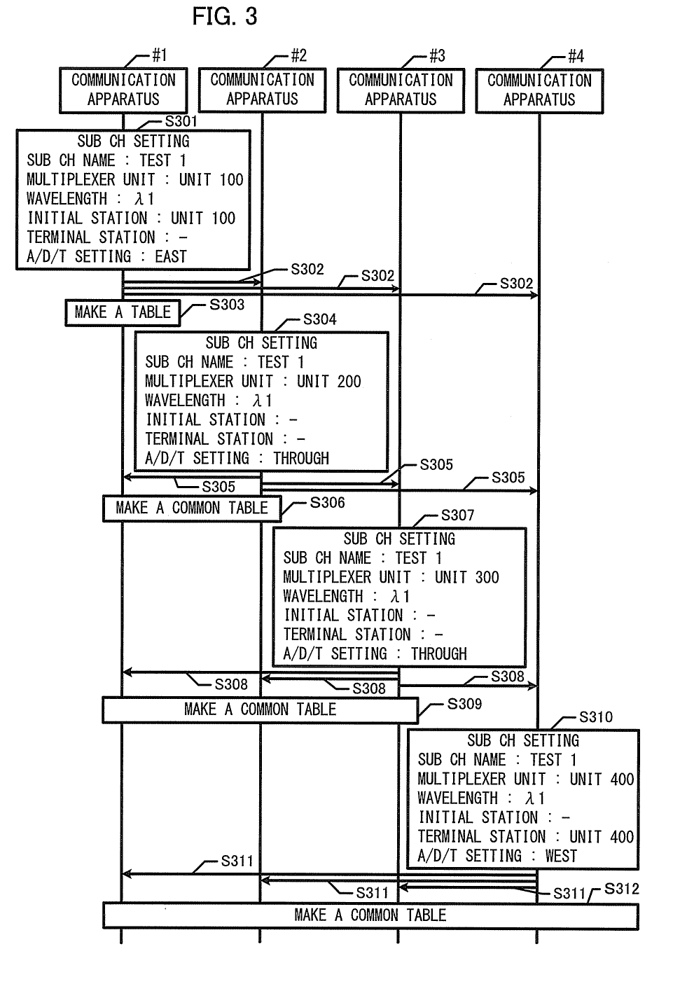

FIG. 3 is a sequence diagram showing an example of a setting procedure of the SUB ch. Each of steps shown in FIG. 3 may be performed on an assumption that the communication apparatuses #1-#4 are physically connected to one another. Setting information at each of the steps shown in FIG. 3 may be sent and received through optical supervisory channels (OSV).

At first, a maintenance worker sets up a SUB ch of the communication apparatus #1 (step S301). The SUB ch is named “Test 1” at the step S301. An object multiplexer unit of the communication apparatus #1 that belongs to the SUB ch “Test 1” is set to be the multiplexer unit 100. A wavelength of use of the SUB ch “Test 1” is set to be λ1.

An initial station of the SUB ch “Test 1” is set to be the multiplexer unit 100 (“UNIT 100” illustrated in FIG. 3). An A/D/T setting of the SUB ch “Test 1” is set to be “East”. Which one of the initial, intermediate and terminal stations the multiplexer unit 100 is set to be is determined in accordance with the A/D/T setting. The A/D/T setting “East” means that the multiplexer unit 100 is the initial station. As the multiplexer unit 100 is not the terminal station, a setting of the terminal station of the SUB ch “Test 1” is left blank.

Then, the communication apparatus #1 notifies each of the communication apparatuses #2-#4 of the setting information set up at the step S301 (step S302). Having been notified as described above, the communication apparatus #2 does not share a table, as the name of the SUB ch “Test 1” included in the setting information notified by the communication apparatus #1 is not set up within the communication apparatus #2, neither does the communication apparatus #3 nor #4.

Then, the communication apparatus #1 makes a table including the setting information set up at the step S301 (step S303). Then, the maintenance worker sets up a SUB ch of the communication apparatus #2 (step S304). The SUB ch is named “Test 1” at the step S304. An object multiplexer unit of the communication apparatus #2 that belongs to the SUB ch “Test 1” is set to be the multiplexer unit 200 (“UNIT 200” illustrated in FIG. 3). A wavelength of use of the SUB ch “Test 1” is set to be λ1.

An A/D/T setting of the SUB ch “Test 1” is set to be “Through”. The A/D/T setting “Through” means that the multiplexer unit 200 is one of the intermediate stations. As the multiplexer unit 200 is not the initial station, a setting of the initial station of the SUB ch “Test 1” is left blank. As the multiplexer unit 200 is not the terminal station, a setting of the terminal station of the SUB ch “Test 1” is left blank.

Then, the communication apparatus #2 notifies each of the communication apparatuses #1, #3 and #4 of the setting information set up at the step S304 (step S305). Having been notified as described above, the communication apparatus #1 sends and receives its own setting information to and from the communication apparatus #2 and makes a common table including the setting information of each other, as the name of the SUB ch “Test 1” included in the setting information notified by the communication apparatus #2 is set up within the communication apparatus #1 (step S306).

Meanwhile, the communication apparatus #3 does not make a table, as the name of the SUB ch “Test 1” included in the setting information notified by the communication apparatus #2 is not set up within the communication apparatus #3, neither does the communication apparatus #4. Then, the maintenance worker sets up a SUB ch of the communication apparatus #3 (step S307). At the step S307, the SUB ch is named “Test 1”. An object multiplexer unit of the communication apparatus #3 that belongs to the SUB ch “Test 1” is set to be the multiplexer unit 300 (“UNIT 300” illustrated in FIG. 3).

A wavelength of use of the SUB ch “Test 1” is set to be λ1. An A/D/T setting of the SUB ch “Test 1” is set to be “Through”. As the multiplexer unit 300 is neither the initial station nor the terminal station, settings of the initial and terminal stations of the SUB ch “Test 1” are left blank. Then, the communication apparatus #3 notifies each of the communication apparatuses #1, #2 and #4 of the setting information set up at the step S307 (step S308).

Having been notified as described above, the communication apparatus #1 sends and receives the own setting information to and from the communication apparatus #3 and makes a common table including the setting information of each other, as the name of the SUB ch “Test 1” included in the setting information notified by the communication apparatus #3 is set up within the communication apparatus #1, and so does the communication apparatus #2 (step S309). Meanwhile, the communication apparatus #4 does not make a table, as the name of the SU Bch “Test 1” included in the setting information notified by the communication apparatus #3 is not set up within the communication apparatus #4.

Then, the maintenance worker sets up a SUB ch of the communication apparatus #4 (step S310). The SUB ch is named “Test 1” at the step S310. An object multiplexer unit of the communication apparatus #4 that belongs to the SUB ch “Test 1” is set to be the multiplexer unit 400 (“UNIT 400” illustrated in FIG. 3). A wavelength of use of the SUB ch “Test 1” is set to be λ1.

A terminal station of the SUB ch “Test 1” is set to be the multiplexer unit 400 (“UNIT 400” illustrated in FIG. 3). An A/D/T setting of the SUB ch “Test 1” is set to be “West”. The A/D/T setting “West” means that the multiplexer unit 400 is the terminal station. As the multiplexer unit 400 is not the initial station, a setting of the initial station of the SUB ch “Test 1” is left blank.

Then, the communication apparatus #4 notifies each of the communication apparatuses #1-#3 of the setting information set up at the step S310 (step S311). Having been notified as described above, the communication apparatus #1 sends and receives its own setting information to and from the communication apparatus #4 and makes a common table including the setting information of each other, as the name of the SUB ch “Test 1” included in the setting information notified by the communication apparatus #4 is set up within the communication apparatus #1, and so do the communication apparatuses #2 and #3 (step S312). The setting procedure ends, then.

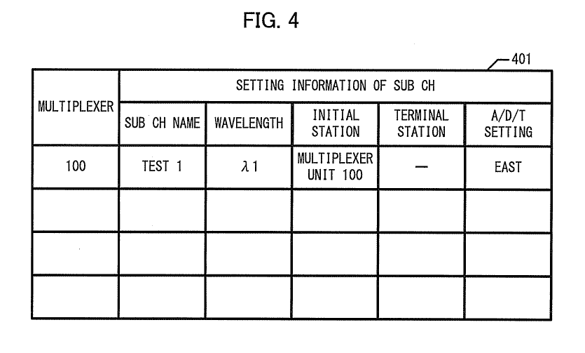

FIG. 4 is a diagram showing the table made at the step S303 shown in FIG. 3. At the step S303 shown in FIG. 3, the communication apparatus #1 makes the table 401 including the setting information of the SUB ch relating to the multiplexer unit 100. The table 401 includes, for each of the object multiplexer units, the setting information of the SUB ch relating to that object multiplexer unit. At this moment, the table 401 includes the setting information of the SUB ch relating to the multiplexer unit 100 only. As the terminal station is not determined, the setting of the terminal station is left blank in the table 401.

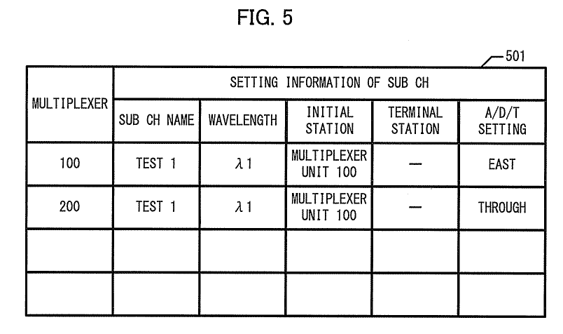

FIG. 5 is a diagram showing the table made at the step S306 shown in FIG. 3. At the step S306 shown in FIG. 3, the communication apparatus #1 makes the table 501 including the setting information of the SUB ch relating to the multiplexer unit 100 and the setting information of the SUB ch relating to the multiplexer unit 200, and so does the communication apparatus #2. Thus, the table 501 includes the setting information of the SUB ch relating to the multiplexer unit 200 in addition to the setting information included in the table 401 shown in FIG. 4.

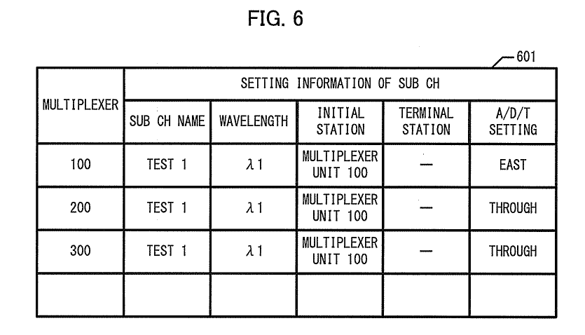

FIG. 6 is a diagram showing the table made at the step S309 shown in FIG. 3. At the step S309 shown in FIG. 3, the communication apparatus #1 makes the table 601 including the setting information of the SUB ch relating to the multiplexer unit 100, the setting information of the SUB ch relating to the multiplexer unit 200 and the setting information of the SUB ch relating to the multiplexer unit 300, and so do the communication apparatuses #2 and #3. Thus, the table 601 includes the setting information of the SUB ch relating to the multiplexer unit 300 in addition to the setting information included in the table 501 shown in FIG. 5.

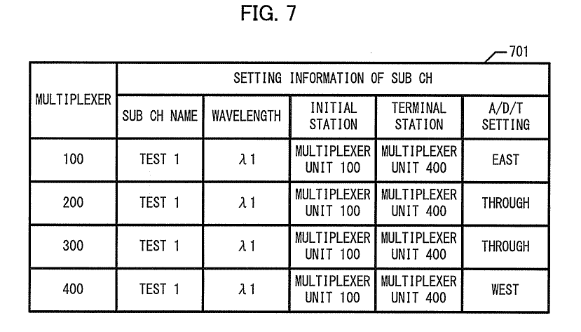

FIG. 7 is a diagram showing the table made at the step S312 shown in FIG. 3. At the step S312 shown in FIG. 3, the communication apparatus #1 makes the table 701 including the setting information of the SUB ch relating to the multiplexer unit 100, the setting information of the SUB ch relating to the multiplexer unit 200, the setting information of the SUB ch relating to the multiplexer unit 300 and the setting information of the SUB ch relating to the multiplexer unit 400, and so do the communication apparatuses #2-#4. Thus, the table 701 includes the setting information of the SUB ch relating to the multiplexer unit 400 in addition to the setting information included in the table 601 shown in FIG. 6.

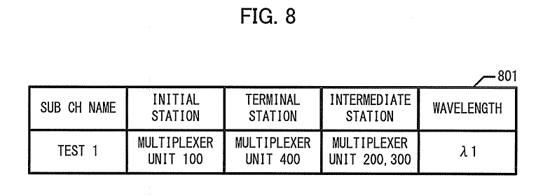

FIG. 8 is a diagram showing a table shared by each of the communication apparatuses. After the steps shown in FIG. 3 end, the communication apparatuses #1-#4 share the table 801 shown in FIG. 8. The table 801 is a summary of the table 701 shown in FIG. 7. The table 801 includes the setting information of the SUB ch name, the initial station, the terminal station, the intermediate stations and the wavelength of use.

More specifically, in the table 801, the SUB ch is named “Test 1”. The initial station is set to be the multiplexer unit 100 of the communication apparatus #1. The terminal station is set to be the multiplexer unit 400 of the communication apparatus #4. The intermediate stations are set to be the multiplexer units 200 and 300 of the communication apparatuses #2 and #3, respectively. The wavelength of use is set to be λ1.

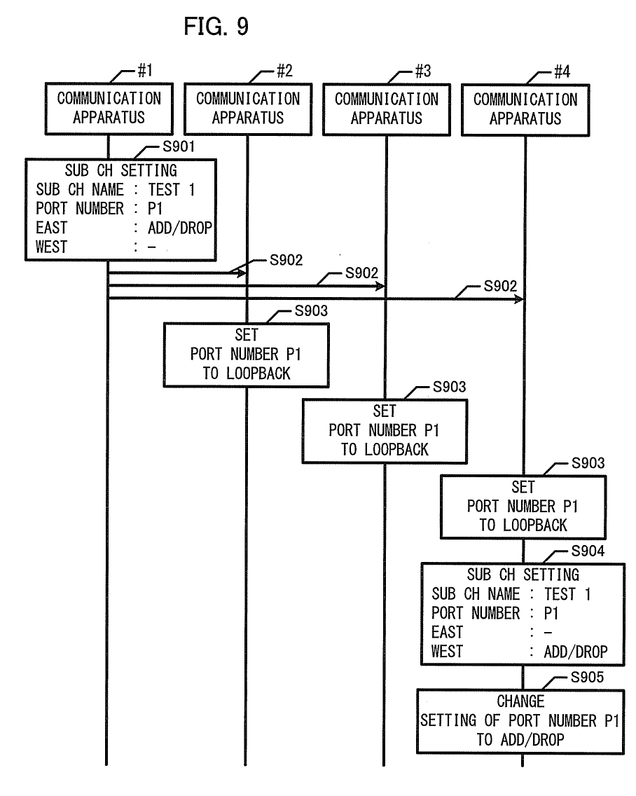

FIG. 9 is a sequence diagram showing an example of a setting procedure of the path. A setting procedure of the path of P1 between the communication apparatuses #1 and #4 shown by the solid line in FIG. 1 is explained here. At first, the maintenance worker sets up a SUB ch of the communication apparatus #1 (step S901). At the step S901, the SUB ch on which the path is set up is named “Test 1”.

The port number of use is set to be P1. The multiplexer unit 100 of the communication apparatus #1 is set to be an add/drop point on the “East” side of this path (East: Add/Drop). Then, the communication apparatus #1 notifies each of the communication apparatuses #2-#4 of the setting information set up at the step S901 (step S902).

Then, having been notified at the step S902, each of the communication apparatuses #2-#4 sets the port number P1 of the SUB ch “Test 1” is set to loop back (step S903). More specifically, each of the communication apparatuses #2-#4 sets the signal processors 230, 330 and 430, respectively, to loop back a received signal addressed to an output port of the port number P1.

Then, the maintenance worker sets up a SUB ch of the communication apparatus #4 (step S904). At the step S904, the SUB ch on which the path is set up is named “Test 1”. The port number of use is set to be P1. The multiplexer unit 400 of the communication apparatus #4 is set to be an add/drop point on the “West” side of this path (West: Add/Drop).

Then, the communication apparatus #4 changes the setting of the port number P1 from loop back to add/drop (step S905). More specifically, upon receiving a signal addressed to the output port of the port number P1, the communication apparatus #4 sets the signal processor 430 to provide the output port 441 with the received signal.

Thus, a signal added to the input port 121 of the multiplexer unit 100 is looped back at the multiplexer units 200 and 300 and dropped from the output port 441 at the multiplexer unit 400 of the communication apparatus #4. A signal added to the input port 421 of the multiplexer unit 400 passes through the multiplexer units 200 and 300 and output from the output port 141 at the multiplexer unit 100 of the communication apparatus #1 so as to be dropped.

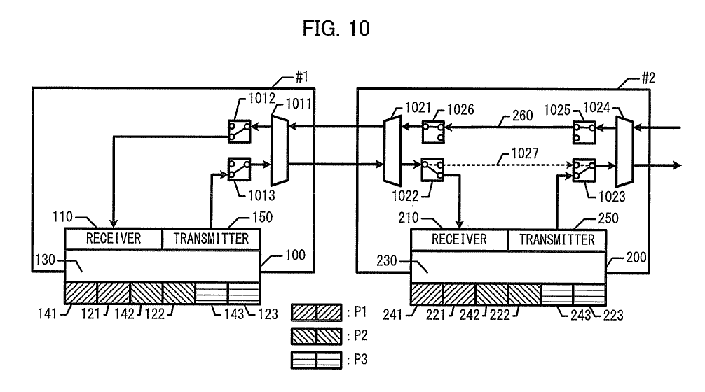

FIG. 10 is a block diagram showing a specific formed example of the communication apparatus. In FIG. 10, each of portions which is a same as the corresponding one shown in FIG. 1 is given a same reference numeral, and its explanation is omitted. Specific formed examples of the communication apparatuses #1 and #2 are shown in FIG. 10. The communication apparatus #1 has a wavelength multiplexer 1011, a switch 1012 and a switch 1013 in addition to the portions shown in FIG. 1. The wavelength multiplexer 1011 is configured to demultiplex the signal transmitted from the communication apparatus #2.

The wavelength multiplexer 1011 is configured to provide the switch 1012 with an output signal of above demultiplexing of the wavelength λ1. The wavelength multiplexer 1011 wavelength division multiplexes a signal of the wavelength λ1 provided by the switch 1013 and a signal of a wavelength λ2 (≠λ1) provided by a multiplexer unit (not shown) of the communication apparatus #1 that is different from the multiplexer unit 100. The wavelength multiplexer 1011 transmits the wavelength division multiplexed signal to the communication apparatus #2.

Having been turned on, the switch 1012 provides the receiver 110 with the signal provided by the wavelength multiplexer 1011. Having been turned off, the switch 1012 cuts off the signal provided by the wavelength multiplexer 1011. The receiver 110 receives a signal provided by the switch 1012. The transmitter 150 provides the switch 1013 with a signal.

Having been turned on, the switch 1013 provides the wavelength multiplexer 1011 with the signal provided by the transmitter 150. Having been turned off, the switch 1013 cuts off the signal provided by the transmitter 150. It is assumed here that both of the switches 1012 and 1013 are turned on so that the multiplexer unit 100 may be used as the initial station of the SUB ch “Test 1”.

The communication apparatus #2 has a wavelength multiplexer 1021, a switch 1022, a switch 1023, a wavelength multiplexer 1024, a switch 1025 and a switch 1026 in addition to the portions shown in FIG. 1. The wavelength multiplexer 1021 is configured to de-multiplex a signal transmitted from the communication apparatus #1. The wavelength multiplexer 1021 provides the switch 1022 with an output signal of above de-multiplexing of the wavelength λ1. The wavelength multiplexer 1021 wavelength division multiplexes a signal provided by the switch 1026, and transmits the wavelength division multiplexed signal to the communication apparatus #1.

Having been turned on, the switch 1022 provides the receiver 210 with the signal provided by the wavelength multiplexer 1021. Having been turned off, the switch 1022 cuts off the signal provided by the wavelength multiplexer 1021. The receiver 210 receives a signal provided by the switch 1022. The transmitter 250 provides the switch 1023 with a signal.

Having been turned on, the switch 1023 provides the wavelength multiplexer 1024 with the signal provided by the transmitter 250. Having been turned off, the switch 1023 cuts off the signal provided by the transmitter 250. The wavelength multiplexer 1024 wavelength division multiplexes a signal of the wavelength λ1 provided by the switch 1023 and a signal of the wavelength λ2 (≠λ1) provided by a multiplexer unit (not shown) of the communication apparatus #2 that is different from the multiplexer unit 100.

The wavelength multiplexer 1024 transmits the wavelength division multiplexed signal to the communication apparatus #3. The wavelength multiplexer 1024 de-multiplexes the signal transmitted from the communication apparatus #3. The wavelength multiplexer 1024 provides the switch 1025 with a de-multiplexed output signal of the wavelength λ1.

Having been turned on, the switch 1025 provides the switch 1026 with the signal provided by the wavelength multiplexer 1024. Having been turned off, the switch 1025 cuts off the signal provided by the wavelength multiplexer 1024. Having been turned on, the switch 1026 provides the wavelength multiplexer 1021 with the signal provided by the switch 1025. Having been turned off, the switch 1026 cuts off the signal provided by the switch 1025.

It is assumed here that both of the switches 1022 and 1023 are turned on so that the multiplexer unit 200 may be used as one of the intermediate stations of the SUB ch “Test 1”. The switches 1025 and 1026 are also turned on so that the through path 260 is formed as shown in FIG. 1.

Both of the switches 1022 and 1023 are turned off so as to remove the multiplexer unit 200 from the SUB ch “Test 1”. In that case, as shown by a dotted line, a through path 1027 is formed to pass the signal from the communication apparatus #1 to the communication apparatus #3. Thus, the multiplexer unit 200 may work as a transmission line configured to pass the signal from the communication apparatus #3 to the communication apparatus #1 and vice versa.

Meanwhile, both of the switches 1022 and 1023 are turned on so as to add the multiplexer unit 200 to the SUB ch “Test 1”. The communication apparatuses #1 and #2 may be configured as described above. The communication apparatuses #3 and #4 may be configured as the communication apparatuses #2 and #1, respectively.

### Second Embodiment

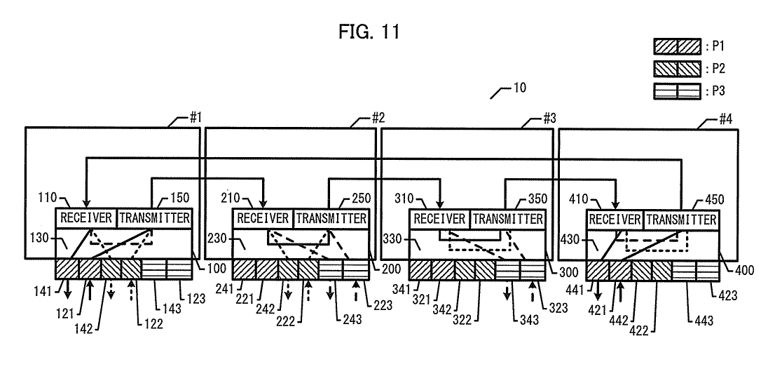

FIG. 11 is a block diagram showing a modification of the communication system shown in FIG. 1. In FIG. 11, each of portions which is a same as the corresponding one shown in FIG. 1 is given a same reference numeral, and its explanation is omitted. FIG. 1 shows a configuration that the communication apparatuses #1 and #4 are directly connected by an optical fiber (the path 11) and the communication apparatuses #1-#4 are connected to form the ring.

Meanwhile, as shown in FIG. 11, the communication apparatuses #1 and #4 need not be directly connected by an optical fiber. That is, the communication apparatuses #1-#4 may physically linearly connected. Thus, the communication system 10 may be implemented by a linear network as well as by a ring network.

As described above, according to the communication system 10 of the embodiment, each of the communication apparatuses #1-#4 may add and drop a signal in the direction from the communication apparatus #1, which is included in the initial station, to the communication apparatus #4, which is included in the terminal station, and may pass the signal through in the direction from the communication apparatus #4, which is included in the terminal station, to the communication apparatus #1, which is included in the initial station, so as to limit the add/drop process in one direction. Thus, the communication system may set up a plurality of paths of a same wavelength between any two of the communication apparatuses without being equipped with a new multiplexer unit.

As described above, the disclosed communication system and the communication apparatus may set up a plurality of paths between any two communication apparatuses without adding a wavelength of use or a multiplexer unit.

In addition to the embodiments described above, following appendix is further disclosed.

(Appendix 1) A communication apparatus included in an intermediate station linearly connected to an initial station and a terminal station, the communication apparatus includes: a receiver for receiving a signal sent from the preceding station; an output port for outputting the received signal addressed to the intermediate station having the second communication apparatus; an input port for being provided an input signal addressed to one of the initial station, other intermediate station, and the terminal station; a transmitter for transmitting the received signal addressed to one of the initial station, other intermediate station, and the terminal station and the input signal to the later station; and a through pass portion for passing a signal sent from the later station to the preceding station.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A communication system having an initial station, an intermediate station and a terminal station linearly connected to one another, the stations being configured to drop or send a received signal, the stations being configured to add another signal to the sent signal, the communication system comprising:
a first communication apparatus included in an initial station, the first communication apparatus transmitting a signal to the intermediate station on a later stage, the first communication apparatus receiving a signal sent from the terminal station and passed through the intermediate station;
a second communication apparatus included in the intermediate station, the second communication apparatus receiving a signal from a preceding station and transmitting the signal to a later station, the second communication apparatus passing a signal from the later station to the preceding station; and
a third communication apparatus included in the terminal station, the third communication apparatus receiving a signal from the intermediate station on a preceding stage, the third communication apparatus transmitting a signal being passed through the intermediate station and being received at the initial station.

2. The communication system according to claim 1, wherein each of the first, second, and third communication apparatus comprises a multiplexer unit for time division multiplexing a signal of a same wavelength so as to transmit and receive the multiplexed signal, and sets up a plurality of paths among one another.

3. The communication system according to claim 1, wherein the initial, intermediate, and terminal stations are connected to form a ring by using an optical fiber, the initial, intermediate and terminal stations being configured to be logically linearly connected.

4. The communication system according to claim 1, wherein the first communication apparatus comprises:
a receiver for receiving a signal addressed to one of the initial station and the intermediate station, the signal being sent from the terminal station and passed the intermediate station;
an output port for outputting the received signal addressed to the initial station;
an input port for being provided an input signal addressed to one of the intermediate station and the terminal station; and
a transmitter for transmitting the received signal addressed to the intermediate station and the input signal to the intermediate station on the later stage.

5. The communication system according to claim 1, wherein the second communication apparatus comprises:
a receiver for receiving a signal sent from the preceding station;
an output port for outputting the received signal addressed to the intermediate station having the second communication apparatus;
an input port for being provided an input signal addressed to one of the initial station, other intermediate station, and the terminal station;
a transmitter for transmitting the received signal addressed to one of the initial station, other intermediate station, and the terminal station and the input signal to the later station; and
a through pass portion for passing a signal sent from the later station to the preceding station.

6. The communication system according to claim 1, wherein the third communication apparatus comprises:
a receiver for receiving a signal sent from the preceding station;
an output port for outputting the received signal addressed to the terminal station;
an input port for being provided an input signal addressed to one of the initial station and the intermediate station,
a transmitter for transmitting the received signal addressed to one of the initial station and the intermediate station and the input signal to the intermediate station.

7. A communication apparatus included in an initial station linearly connected to an intermediate station and an terminal station, the communication apparatus comprising:
a receiver for receiving a signal addressed to one of the initial station and the intermediate station, the signal being sent from the terminal station and passed the intermediate station;
an output port for outputting the received signal addressed to the initial station;
an input port for being provided an input signal addressed to one of the intermediate station and the terminal station; and
a transmitter for transmitting the received signal addressed to the intermediate station and the input signal to the intermediate station on the later stage.

8. A communication apparatus included in a terminal station linearly connected to an initial station and an intermediate station, the communication apparatus comprising:
a receiver for receiving a signal sent from the preceding station;
an output port for outputting the received signal addressed to the terminal station;
an input port for being provided an input signal addressed to one of the initial station and the intermediate station,
a transmitter for transmitting the received signal addressed to one of the initial station and the intermediate station and the input signal to the intermediate station.
